(19) United States
(12) Patent Application Publication
(10) Pub. No.: US 2023/0373762 A1
(43) Pub. Date: Nov. 23, 2023

(54) PORTABLE ROOFTOP HOIST ASSEMBLY AND METHOD

(71) Applicant: Kerim Huezo, Las Vegas, NV (US)

(72) Inventor: Kerim Huezo, Las Vegas, NV (US)

(21) Appl. No.: 18/199,622

(22) Filed: May 19, 2023

Related U.S. Application Data
(60) Provisional application No. 63/344,106, filed on May 20, 2022.

(51) Int. Cl. B66C 23/20

(52) U.S. Cl. CPC B66C 23/205

(57) ABSTRACT

A portable hoist assembly. The hoist assembly includes an attachment assembly to releasably attach the hoist assembly to a rooftop parapet wall or similar and a rotatable line pulling assembly (e.g., a winch) to pull lengths of line upward to hoist objects from the ground to the rooftop, and to release lengths of line downward to lower objects from the rooftop to the ground. The rotatable line pulling assembly is rotated using a power tool (e.g., a power drill) releasably coupled to its hub. The hoist assembly also includes a base support configured between the line pulling assembly and the top of the parapet wall to provide vertical support to the hoist. The hoist assembly also includes a separate ladder attachment assembly for attaching the hoist to a ladder.

### FIELD OF THE INVENTION

This invention relates to hoists, including a portable rooftop hoist.

### BACKGROUND

During building construction and maintenance, it is oftentimes necessary to hoist objects from the ground level to the rooftop of the building. For example, tradesmen in the commercial and residential service professional industry (e.g., HVAC technicians, electricians, plumbers, telecommunications techs, etc.) may be required to hoist heavy equipment (such as compressors) to the rooftop for installation.

However, hoists may not be easily accessible, such that the workers may be required to pull the objects up by hand. In addition, when hoists are available, the hoists are oftentimes bulky, cumbersome to assemble, and difficult to maneuver and operate. In addition, many hoists require more than one person to operate.

Accordingly, there is a need for a portable rooftop hoist that may be powered using a standard power drill and that may be operated by a single user.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a side view of a hoist assembly according to exemplary embodiments hereof;

FIG. 2 shows an isometric view of a hoist assembly according to exemplary embodiments hereof;

FIG. 3 shows a side view and a rear view of a separate attachment assembly according to exemplary embodiments hereof; and

FIG. 4 shows a hoist assembly configured with a separate attachment assembly according to exemplary embodiments hereof.

### DETAILED DESCRIPTION OF EXEMPLARY EMBODIMENTS

In general, the assembly according to exemplary embodiments hereof includes a portable hoist assembly. The hoist assembly may be adapted for use on a rooftop to hoist objects from a lower level (e.g., ground level) to an upper level (e.g., the rooftop). The hoist is portable and able to be attached to a parapet wall of a building, other mounting accessories (e.g., such as a ladder mount as described herein), and/or other support structures during use. The hoist may include a rotatable hub configured with a line pulling mechanism (e.g., a line puller or winch) to pull a length of line up and down. The hub is adapted to be removably coupled to a rotating power tool (e.g., a power drill) to drive the hoist during use.

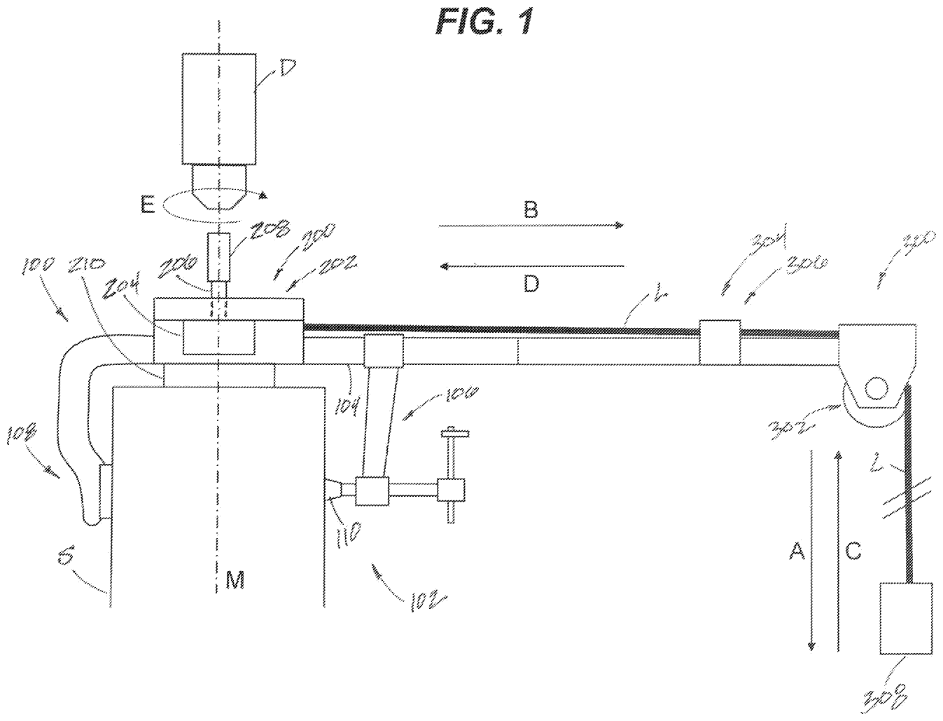

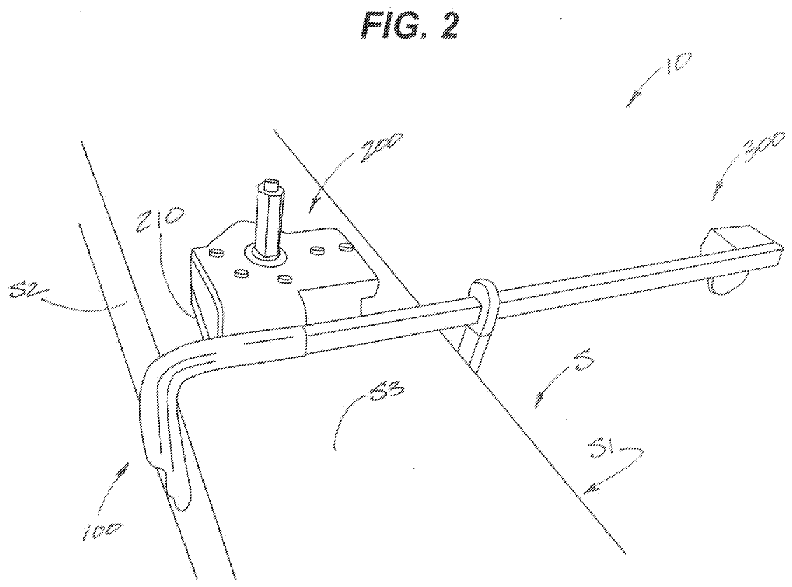

FIG. 1 shows a side view of the portable hoist assembly 10 and FIG. 2 shows a general isotropic view of the portable hoist assembly 10 secured to a support structure S, e.g., a parapet wall. As shown, the parapet wall S may include a front surface S1, a rear surface S2, and a top surface S3. The front and rear surfaces S1, S2 may be generally parallel with one another and the top surface S3 may be generally orthogonal to the front and rear surfaces S1, S2.

In one exemplary embodiment hereof, as shown in FIGS. 1 and 2, the portable rooftop hoist assembly 10 (also referred to herein as simply the assembly 10) includes an attachment assembly 100, a line pulling assembly 200, and a pulley assembly 300. In general, the attachment assembly 100 attaches the assembly 10 to a support structure for stable use, the line pulling assembly 200 pulls and releases lengths of line L to raise and lower the objects being hoisted, and the pulley assembly 300 guides the length of line L during use. The line pulling assembly 200 includes a rotatable hub that is releasably coupled to a power tool (e.g., a drill) which provides powered rotation to the hub to pull and release the line L. The assembly 10 also may include a separate attachment assembly 400 for securing the hoist assembly 10 to a ladder or other type(s) of similar structures. The assembly 10 may include other elements as necessary to fulfill its functionalities.

As described herein, the line pulling assembly 200 may be removably attached to a separate tool (e.g., a power drill) that may rotate the assembly 200, thereby causing the line L to extend and/or retract. Accordingly, the assembly 10 may be regarded as a removable accessory to the separate tool (the power drill) for its application. However, it also is understood that the assembly 10 may be integrated into a rotating power tool and/or another type of rotating mechanism as a permanent fixture.

For the purposes of this specification, the hoist assembly 10 will be described primarily with use with a power drill. It is understood however that the hoist assembly 10 may be used with other types of tools (manual and/or powered), and that the scope of the portable hoist assembly 10 is not limited in any way by the type of tools that it may be used with. It is preferable that the power tools be capable of rotating with sufficient strength in order to rotate the assembly 200.

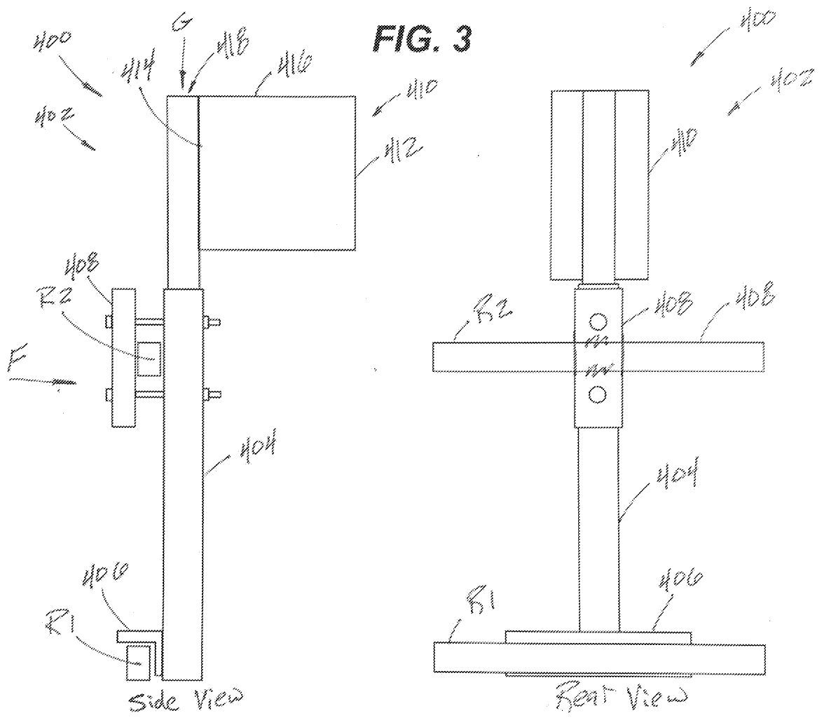

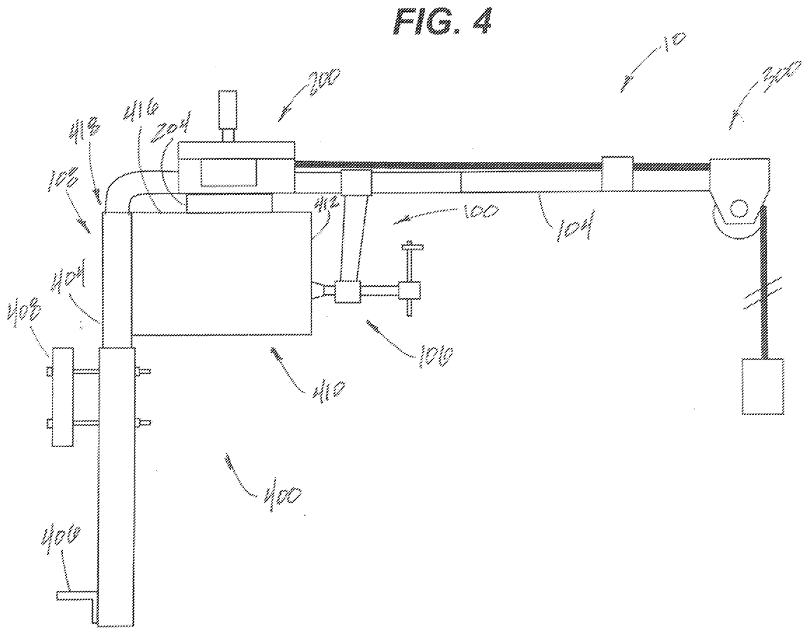

Further details of the hoist assembly 10, attachment assembly 100, line pulling assembly 200, and pulley assembly 300 will be described below in relation to FIGS. 1-2. The separate attachment assembly 400 will be descried in relation to FIGS. 3-4.

Attachment Assembly 100

In some embodiments, as shown in FIG. 1, the attachment assembly 100 includes an attachment mechanism 102. In some embodiments, the attachment mechanism 102 includes an elongate rail 104 with a first clamping member 106 (e.g., a forward clamping member) and a second clamping member 108 (e.g., a rear clamping member). In one example, the first clamping member 106 is slidably configured with the rail 104 so that it may be positioned along the rail's longitudinal length as required. In some embodiments, the second clamping member 108 is stationary. However, it also is contemplated that the first clamping member 106 may be stationary and/or the second clamping member 108 may be slidable and/or any combination(s) thereof.

In general, the attachment mechanism 102 may be placed transverse a support structure S (e.g., a parapet wall as shown in FIG. 2, a rail on a building rooftop, etc.) with the first and second clamping members 106, 108 opposing one another on either side of the structure S. In this way, the first and/or second clamping member 106, 108 may be adjusted inward (e.g., by rotating the adjustable foot 110 on the first clamping member 106 via the member's handle) to secure the support structure S therebetween. In this way, the attachment members 106, 108 may be tightened to secure the attachment assembly 100 to the structure S and/or loosened to detach the attachment assembly 100.

In some embodiments, the elongate rail 104 may extend beyond the first and/or second clamping members 106, 108 (e.g., towards the pulley assembly 300 and/or on either side) to accommodate the line pulling assembly 200, and/or the pulley assembly 300 as described in other sections. In some embodiments, the length of the rail 104 is adjustable (e.g., the rail 104 may be telescoping or similar) such that the location of the pulley assembly 300 with respect to the attachment assembly and/or the line pulling assembly 200 may be adjusted.

It is understood that the attachment assembly 100 may include other types of attachment mechanisms 102, such as, without limitation, spring-loaded clamps, latches, brackets, braces, other types of attachment mechanisms, and any combinations thereof.

Line Pulling Assembly 200

In some embodiments, the line pulling assembly 200 includes a housing 202, a rotatable line gripping mechanism 204, and a hub 206 configured with the rotatable line gripping mechanism 204 to affect its movement. The assembly 200 also may include a coupler 208 designed to couple the hub 206 to a power tool D.

In some embodiments, the line gripping mechanism 204 includes a rotatable gripping wheel adapted to receive and grip a longitudinal section of line L and to pull the line L (e.g., by rotating) in a predetermined direction. For the purposes of this specification, the term line means any type of suitable flexible elongate structure including, but not limited to, rope (e.g., ⅜″ rope), chain, webbing, cable, other suitable type(s) of lines, and any combinations thereof. The line may comprise natural and/or synthetic fibers, plastic, metal, composite materials, other suitable types of materials, and any combinations thereof.

In one example, as shown in FIG. 1, the line gripping mechanism 204 includes a wheel adapted to receive and pull lengths of the line L in the direction of the arrow D by rotating about its center axis M in the direction of the arrow E in order to hoist objects. In some embodiments, the line gripping mechanism 204 may include a non-spooling line winch, a spooling winch, other types of winches and/or line gripping and pulling mechanisms, and any combinations thereof.

In some embodiments, as shown in FIG. 1, the line gripping mechanism 204 is coupled with a hub 206, preferably at the line gripping mechanism's middle point (e.g., at the center of the wheel at the center axis M). In this way, as the hub 206 is caused to rotate, the line gripping mechanism 204 also is caused to rotate in the same direction. In some embodiments, the hub 206 includes a coupler 208 (e.g., a hexagonal pin or similar) for coupling the hub 206 to a power drill D. For example, in some embodiments, a first end of the coupler 208 may be attached to the hub 206 and a second end of the coupler 208 may extend away from the hub 206. In this way, as shown in FIG. 1, the second end of the coupler 208 may be exposed and may be removably coupled to the chuck of the power drill D. The power drill D may then be activated to rotate the hub 206 (e.g., in the direction of the arrow E) thereby rotating the line gripping mechanism 204. When rotating, the line gripping mechanism 204 may receive, grip, and pull lengths of line L in the direction of the arrow D to hoist objects.

In some embodiments, the line gripping mechanism 204 may be controlled to rotate in an opposite direction (e.g., opposite to the direction depicted by the arrow E) in order to facilitate the extension of the line L in the direction of the arrow B. This controlled extension may be powered by the power drill D (e.g., by rotating in the opposite direction of the arrow E), may be manual (e.g., using a crank shaft configured with the mechanism 204), and/or may be controlled by other means. In this way, objects attached to the distal end of the line L may be lowered by the hoist assembly 10.

In other embodiments, the line gripping mechanism 204 may be designed to controllably release or otherwise disengage the line L such that the line L is free to move in the direction of the arrow B to lower the objects. The release of the line L may be controlled by a braking system integrated into the line gripping mechanism 204 so that the speed of the line L being released may be regulated. In other embodiments, as shown in FIG. 1, the assembly 10 includes a line braking mechanism 304 to regulate the release of the line L as described in other sections.

In some embodiments, as shown in FIG. 1, the hoist assembly 10 includes a base support member 210 configured on an underside of the rail 104 and/or on an underside of the line pulling assembly 200. In this configuration, and during use, the base support 210 extends between the line pulling assembly 200 (via the housing 202 and any intermediary elements) and the top of the parapet wall (or other support structure) thereby providing vertical support to the assembly 10.

For example, to set up the hoist assembly 10, the assembly 10 is placed on top of the parapet wall with the base support member 210 engaging the top of the wall. In this position, the coupler 208 on the opposite side of the assembly 10 extends upward (preferably vertically). The assembly 10 is then clamped to the parapet wall using the first and second clamping members 106, 108 as described above. The user then engages the power drill D with the coupler 208 to rotate the hub 206 and the rotatable line gripping mechanism 204 configured thereto. With the base support member 210 sandwiched between the line gripping mechanism 204 and the top of the wall, the user may apply a downward force to the power drill D to hold it in place and to drive the hub 206. The downward force vector applied by the user extends from the power drill D, through the coupler 208, through the hub 206, through the line gripping mechanism 204, through the base support member 210, and into the top of the parapet wall (preferably all along the center axis M as shown). In this way, the downward force applied by the user from the base support member 210 to the parapet wall holds the hoist assembly 10 stable during the hoisting of the object.

In some embodiments, the base support member 210 includes a sufficient footprint (e.g., between the first and second clamping members 106, 108 and extending outward laterally on either side) to provide sufficient base support to the assembly 10 (e.g., about six inches wide and//or wide or greater). In some embodiments, the coupler 208, the hub 206, the line gripping mechanism 204, and the base support member 210 are all aligned along the center axis M as shown in FIG. 1. In some embodiments, base support member 210 is centered along the center axis M. In some embodiments, the center axis M is orthogonal to the top surface of the parapet wall (or other support structure). In some embodiments, the center axis M is parallel to the front and/or rear surfaces of the parapet wall (or other support structure).

Pulley Assembly 300

In some embodiments, as shown in FIG. 1, the pulley assembly 300 includes a first pully 302 coupled to a distal portion of the assembly's elongate rail 104. The first pulley 302 is adapted to receive and guide lengths of line L to and from the line pulling assembly 200. For example, in some embodiments, the first pulley 302 may receive lengths of line L from below in the direction of the arrow C, and subsequently translate the lengths of line L into the direction of the arrow D to be fed into the line gripping mechanism 204. This may occur when the line gripping mechanism 204 is pulling the line L and an object is being hoisted upward.

In other embodiments, the first pulley 302 may receive lengths of line L from the line gripping mechanism 204 in the direction of the arrow B and translate the lengths of line L into the direction of the arrow A. This may occur when the line gripping mechanism 204 is releasing the line L and an object is being lowered.

In some embodiments, the pulley assembly 300 includes a line braking mechanism 304 located on the assembly's elongate rail 104 between the first pulley 302 and the line gripping mechanism 204. The line braking mechanism 304 may receive line L being released from the line gripping mechanism 204 and control the speed of the line L. In this way, the downward speed of the object being lowered also may be controlled. This braking functionality may be controlled by the user, may include speed/braking settings that may be adjusted prior to use, may be automatic, and/or any combinations thereof.

In some embodiments, the line braking mechanism 304 may include a safety brake 306 that is automatically engaged when and if the line L is inadvertently released from the line gripping mechanism 204 (e.g., during a failure of the mechanism 204). For example, the safety brake 306 may sense a sudden release of the line L and subsequently automatically engage to stop movement of the line L. This may in turn stop the object being hoisted from falling downward thereby preventing threat of damage and injury.

In some embodiments, the line braking mechanism 304 also acts to guide the line L during use. For example, the mechanism 304 may guide the line L from the line gripping mechanism 204 to the first pulley 302 (e.g., when the line L is moving in the direction of the arrow B) and/or guide the line L from the first pulley 302 to the line gripping mechanism 204 (e.g., when the line L is moving in the direction of the arrow D).

In some embodiments, the line braking mechanism 304 may include a controllable pulley, wheel, hoop, slot, aperture, plate, other types of braking and/or guiding mechanisms, and any combinations thereof.

In some embodiments, an attachment mechanism 308 is coupled to the distal end of the line L to releasably secure an object to be hoisted. In some embodiments, the attachment mechanism 308 includes a hook, a clamp, a strap, a net, webbing, a carabiner, a platform, a cage, a box, a bucket, other types of attachment mechanisms, and any combinations thereof.

Separate Attachment Assembly 400

In some embodiments, the assembly 10 includes a separate attachment assembly 400 to attach the assembly 10 to structures other than a rooftop parapet wall. For example, in some embodiments, the separate attachment assembly 400 includes a ladder attachment assembly 402 used to attach the hoist assembly 10 to a conventional ladder (e.g., straight ladders, extension ladders, step ladders, ladders attached to the side of a building, etc.).

FIG. 3 shows a side view and a rear view (from the perspective of the arrow F) of a ladder attachment assembly 402 according to exemplary embodiments hereof. In both views, the ladder attachment assembly 402 is configured with a first ladder rung R1 (e.g., a lower rung) and a second ladder rung R2 (e.g., an upper rung). The left and right side support structures of the ladder that hold the rungs R1, R2 in place have been omitted for clarity.

In some embodiments, the ladder attachment assembly 402 includes an upright support beam 404 with a lower end and an upper end. The length of the upright support beam 404 is preferably adjustable (e.g., the beam 404 may be telescoping or similar). In some embodiments, a first bracket member 406 is coupled to the lower end of the beam 404 and is designed to rest on and/or otherwise releasably engage a first rung R1 of a ladder. For example, in some embodiments, the bracket member 406 includes an “L” shaped member that rests against the top and front side surfaces of the rung R1. The bracket member 406 may include other types of attachment members as suitable.

In some embodiments, a second bracket member 408 is releasably coupled to an intermediate location on the upright support beam 404 between its first and second ends. In some embodiments, the second bracket member 408 includes a plate (or other suitable structure(s)) that may be releasably coupled to the upright beam 404 using attachment members such as bolts that pass through holes in the second bracket member 408 and corresponding holes in the upright beam 404. It is preferred that the upright beam 404 include a plurality of holes located sequentially between its first and second ends so that the second bracket member 408 may be positioned and coupled to the beam 404 at any desired location. In this way, the location of the second bracket member 408 may be chosen to correspond to the location of the second ladder rung R2 and be attached thereto. For example, the first bracket member 406 may first be engaged with the first ladder rung R1, and then the second bracket member 408 may be positioned to engage the second ladder rung R2 as shown in FIG. 3 and be attached to the upright beam 404 at this location. The second bracket member 408 may then be tightened (e.g., using the bolts) such that the second rung R2 is sandwiched (or otherwise engaged) between the second bracket 408 and the upright beam 404 and be secured thereto. In this way, the upright beam 404 may be secured to the ladder rungs R1, R2.

In some embodiments, as shown in FIG. 3, the ladder attachment assembly 402 includes a hoist mounting member 410 coupled to the upper end of the upright beam 404. The hoist mounting member 410 preferable includes a cuboid or other suitably formed structure that includes a body with a front surface 412, a rear surface 414, and a top surface 416. During use, the front and rear surfaces 412, 414 are preferably generally parallel and vertical when the ladder attachment assembly 402 is secured to the ladder as shown. The purpose of the hoist mounting member 410 is to provide a mounting structure (e.g., similar to the parapet wall described in other embodiments) for the portable hoist assembly 10 to be connected. For example, the hoist assembly 10 may be attached to the mounting member 410 by placing the mounting member 410 between the hoist assembly's first and second clamping members 106, 108 and engaging the first and second clamping members 106, 108 against the mounting member's front and rear surfaces 412, 414, respectively. Given this, it is preferable that the mounting member 410 be comprised of a strong material such as metal, hard plastic, wood, etc., so that it may not deform when clamped between the clamping members 106, 108. In addition, the distance between its front and rear surfaces 412, 414 is preferably chosen to fit between the clamping members 106, 108 in a similar fashion as a parapet wall may fit as described in other sections.

In some embodiments, the top end of the upright beam 404 is open such that it may receive the hoist assembly's second clamping member 108 through its top opening 418, e.g., in the direction of the arrow G in FIG. 3. Accordingly, it is preferable that the top opening 418 is sized to receive the second clamping member 108. In this way, the second clamping member 108 may be inserted into the top opening 418 resulting in the base support member 210 engaging the top surface 416 of the hoist mounting member 410 as shown in FIG. 4. The assembly's first clamping member 106 may then be adjusted to engage the mounting member's front surface 412 and tightened. In this way, the first clamping member 106 engages the mount's front surface 412, the second clamping member 108 engages the mount's rear surface 414 (via the inner sidewall of the ladder attachment assembly's upright beam 404), and the base support member 210 engages the mount's upper surface 416. It also is contemplated that the second clamping member 108 may be configured to engage the rear outside wall of the ladder assembly's upright beam 404 opposite the hoist mounting member 410.

With the ladder attachment assembly 402 secured to the first and second rungs R1, R2 of the ladder, the ladder may be positioned against a wall and/or configured to be freestanding at a desired location, and the portable hoist assembly 10 may be configured with the attachment assembly 402 for use in hoisting objects.

In Use

In some embodiments, the hoist assembly 10 is used to hoist objects from ground level to a rooftop, and subsequently, to lower objects from a rooftop to ground level.

During use, a user may attach the hoist assembly 10 to the side parapet wall of a rooftop (or any other suitable support structure S) using the attachment assembly 100 as described herein. It is preferable that the attachment mechanism's elongate clamp rail 104 extend out over the edge of the rooftop so that the first pulley 302 may have an unobstructed line of sight to the ground.

Next, the line pulling assembly 200 (e.g., the line gripping mechanism 204) is disengaged (if required) so that sufficient lengths of line L may be lowered from the first pulley 302 to the ground below.

Next, an object to be hoisted may be releasably attached to the end of the line L using the attachment mechanism 308.

The user may then couple a power drill D with the line pulling assembly's hub 206 via the coupler 208 and engage the drill to rotate the hub 206. The hub 206 in turn may cause the line gripping mechanism 204 to rotate causing it to receive, grip, and pull lengths of line L in the direction of the arrow D. This in turn may cause the line L, the attachment mechanism 308, and the object secured to the attachment mechanism 308 to be hoisted in the direction of the arrow C.

It is understood that the steps described above are meant for demonstration and that additional steps may be performed, not all of the described steps may be performed, and the steps may be taken in different orders. It also is understood that the scope of the assembly 10 is not limited in any way by the steps taken during its use.

It also is understood that any aspect and/or element of any embodiment of the assembly 10 described herein or otherwise may be combined with any other aspect and/or element of any other embodiment described herein or otherwise in any way to form additional embodiments of the assembly 10 all of which are within the scope of the assembly 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A hoist assembly adapted to be attached to a parapet wall including a parapet front surface, a parapet rear surface, and a parapet top surface, the hoist assembly comprising:
a first clamping member adapted to engage the parapet front surface, and a second clamping member opposite the first clamping member and adapted to engage the parapet rear surface;
a line gripping assembly configured to receive a line and to pull the line in a first direction;
a base member configured with the line gripping assembly and adapted to engage the parapet top surface;
a hub coupled to the line gripping assembly and attachable to the rotatable power tool;
wherein the rotatable power tool when attached to the hub causes the hub to rotate which causes the line gripping assembly to rotate about a center axis and to pull the line in the first direction.

2. The hoist assembly of claim 1 further comprising a first support beam configured with the first clamping member and with the second clamping member, the support beam configured to extend across the parapet top surface and including a support beam distal end extending outward beyond the parapet front surface.

3. The hoist assembly of claim 2 further comprising a pulley assembly configured with the support beam's distal end, the pulley assembly adapted to affect an orientation of the line.

4. The hoist assembly of claim 3 wherein the pulley assembly is adapted to translate the line from a substantially horizontal orientation to a substantially vertical orientation.

5. The hoist assembly of claim 1 wherein the center axis is orthogonal to the parapet top surface.

6. The hoist assembly of claim 1 wherein the rotatable hub is adapted to rotate about the center axis.

7. The hoist assembly of claim 1 wherein the base member includes a bottom surface that when engaged with the parapet top surface is orthogonal to the center axis.

8. The hoist assembly of claim 1 wherein a middle point of the base member is aligned with the center axis.

9. The hoist assembly of claim 1 further comprising a braking assembly adapted to affect movement of the line.

10. The hoist assembly of claim 1 further comprising a ladder attachment assembly comprising:
a second support beam;
a first attachment bracket coupled to the second support beam and adapted to engage a first ladder rung;
a second attachment bracket coupled to the second support beam and adapted to engage a second ladder rung; and
a mount coupled to the second support beam and adapted to be secured between the first and second clamping members.

11. The hoist assembly of claim 10 wherein the second support beam includes a first end, a second end opposite the first end, and a beam body extending between the first end and the second end;
wherein the first attachment bracket is coupled to the first end, the second attachment bracket is coupled to the beam body between the first end and the second end, and the mount is coupled to the second end.

12. The hoist assembly of claim 10 wherein the second attachment bracket is removably coupled to the second support beam.

13. The hoist assembly of claim 10 wherein the mount includes a top surface that is adapted to engage the base member when the mount is secured between the first and second clamping members.

14. The hoist assembly of claim 11 wherein the second support beam's second end is open and adapted to receive at least a portion of the second clamping member when the mount is secured between the first and second clamping members.

15. A hoist assembly comprising:
a first clamping member and a second clamping member opposite the first clamping member;
a line gripping assembly adapted to receive a line and to pull the line in a first direction;
a base member configured with the line gripping assembly and including a base member bottom surface;
a hub coupled to the line gripping assembly and attachable to rotatable power tool;
a first support beam configured with the first clamping member and with the second clamping member;
a second support beam;
a first attachment bracket coupled to the second support beam and adapted to engage a first ladder rung;
a second attachment bracket coupled to the second support beam and adapted to engage a second ladder rung; and
a mount coupled to the second support beam and adapted to be secured between the first and second clamping members and to engage the base member bottom surface;
wherein the rotatable power tool when attached to the rotatable hub causes the hub to rotate which causes the line gripping assembly to rotate about a center axis and to pull the line in the first direction.

16. The hoist assembly of claim 15 wherein the first support beam includes a first support beam distal end extending outward beyond the first clamping member.

17. The hoist assembly of claim 15 further comprising a pulley assembly configured with the first support beam's distal end, the pulley assembly adapted to affect an orientation of the line.

18. The hoist assembly of claim 15 wherein a center point of the base member is aligned with the center axis.
